(19) United States
(12) Patent Application Publication
(10) Pub. No.: US 2017/0150256 A1
(43) Pub. Date: May 25, 2017

(54) AUDIO ENHANCEMENT

(71) Applicant: HARMAN BECKER AUTOMOTIVE SYSTEMS GMBH, Karlsbad (DE)

(72) Inventors: Markus CHRISTOPH, Straubing (DE); Gerhard PFAFFINGER, Resenburg (DE); Nikos ZAFEIROPOULOS, Straubing (DE)

(73) Assignee: HARMAN BECKER AUTOMOTIVE SYSTEMS GMBH, Karlsbad (DE)

(21) Appl. No.: 15/356,026

(22) Filed: Nov. 18, 2016

(30) Foreign Application Priority Data
Nov. 20, 2015 (EP) 15195529.1

(51) Int. Cl. H04R 3/00; H04R 5/027

(52) U.S. Cl. CPC H04R 3/005; H04R 5/027; H04R 2499/13; H04R 2410/01; H04R 2430/21; H04R 2430/01

(57) ABSTRACT

An exemplary audio enhancement system and method includes providing a first audio signal in a first audio signal path with a first microphone, and processing the first audio signal with a first signal processing structure. The first microphone is optimized for the first signal processing structure in terms of at least one of the first microphone's position and the first microphone's performance. Further included is providing a second audio signal in a second audio signal path with a second microphone, and processing the second audio signal with a second signal processing structure. The second microphone is optimized for the second signal processing structure in terms of at least one of the second microphone's position and the second microphone's performance. The second signal processing structure being different from the first signal processing structure.

### CROSS-REFERENCE TO RELATED APPLICATIONS

This application claims priority to EP application Ser. No. 15195529.1 filed Nov. 20, 2015, the disclosure of which is hereby incorporated in its entirety by reference herein.

### TECHNICAL FIELD

The disclosure relates to an audio enhancement system and method.

### BACKGROUND

In modern automotive vehicles many different acoustic systems relying on microphone signals are available such as, for example, dynamic equalization control, which adapts the volume and/or the equalizing of an audio signal to a dynamically changing background noise, in-vehicle communication, which enables or at least facilitates communication of passengers in an interior of the vehicle, active noise control, which acoustically damps noise originating from, e.g., the road or the engine, hands-free communication, which enables telephone calls without taking the hands off the steering wheel, and beamforming, which creates a spatial filter to pinpoint a microphone array to a speaker at a certain direction in the room, etc. It is desired to further improve the performance of the acoustic systems in the interior of a vehicle.

### SUMMARY

An exemplary audio enhancement system includes a first audio signal path with a first microphone configured to provide a first audio signal, and with a first signal processing structure configured to process the first audio signal. The first microphone is optimized for the first signal processing structure in terms of at least one of the first microphone's position and the first microphone's performance. The system further includes a second audio signal path with a second microphone configured to provide a second audio signal, and with a second signal processing structure configured to process the second audio signal. The second microphone is optimized for the second signal processing structure in terms of at least one of the second microphone's position and the second microphone's performance. The second signal processing structure is different from the first signal processing structure. The system further includes a signal coupler configured to process the first audio signal and to supply the processed first audio signal to the second signal processing structure. The processing of the first audio signal includes enhancing the first audio signal for use in the second signal processing structure.

An exemplary audio enhancement method includes providing a first audio signal in a first audio signal path with a first microphone, and processing the first audio signal with a first signal processing structure. The first microphone is optimized for the first signal processing structure in terms of at least one of the first microphone's position and the first microphone's performance. The method further includes providing a second audio signal in a second audio signal path with a second microphone, and processing the second audio signal with a second signal processing structure. The second microphone is optimized for the second signal processing structure in terms of at least one of the second microphone's position and the second microphone's performance. The second signal processing structure is different from the first signal processing structure. The method further includes processing the first audio signal and supplying the processed first audio signal to the second signal processing structure. The processing of the first audio signal includes enhancing the first audio signal for use in the second signal processing structure.

### BRIEF DESCRIPTION OF THE DRAWINGS

The disclosure may be better understood from reading the following description of non-limiting embodiments, with reference to the attached drawings, wherein below:

FIG. 1 is a schematic diagram illustrating a multi-microphone arrangement in the interior of a vehicle;

FIG. 2 is a block diagram illustrating an active noise control system supplied with an additional microphone signal from an in-car-communication system;

FIG. 3 is a block diagram illustrating an exemplary hands-free communication system supplied with additional microphone signals from an in-car-communication system, an active noise control system, and a dynamic equalization control system;

FIG. 4 is a block diagram illustrating an exemplary active noise control system supplied with an additional microphone signal;

FIG. 5 is a block diagram illustrating an exemplary hands-free communication system with beamformer supplied with additional microphone signals from an active noise control system and an in-car-communication system;

FIG. 6 is a schematic diagram illustrating an exemplary in-car communication system with beamforming, echo cancelling and dynamic equalization properties supplied with an additional microphone signal; and

FIG. 7 is a flow chart illustrating an exemplary audio enhancement method.

### DETAILED DESCRIPTION

For example, to ensure in an automobile interior that, during a hands-free telephone conversation of one passenger, another passenger is not able to hear the conversation, a masking sound may be generated which may not only mask sound travelling to the other passenger but may also disturb the one passenger while speaking—this concept will be called “sound shower” in the following. At the same time, hands-free systems require exactly the opposite, as speech is the desired signal and background noise should be blocked as well as possible. For this purpose, a single directional microphone or a multiplicity of microphones in connection with beamforming technology is commonly used. The single microphone or the microphone array with subsequent beamforming circuit may be placed in the headliner or a pillar close to a passenger's mouth. In the case of in-vehicle communication, it is required to pick-up speech in the best way possible, however, not only at one position as is in hands-free systems, but at more positions, dependent on whether the in-vehicle communication systems is setup as a unidirectional or a bidirectional system. In in-vehicle communication systems, single microphones are commonly placed in grab handles adjacent to the headliner. In active noise control systems, it is again the noise field and not the speech signals that matter. Ideally, the noise fields close to the passengers' ears at all positions are evaluated without picking up speech from that location, which may be achieved with microphones placed in the headliner above each head position or in the headrests at all seat positions.

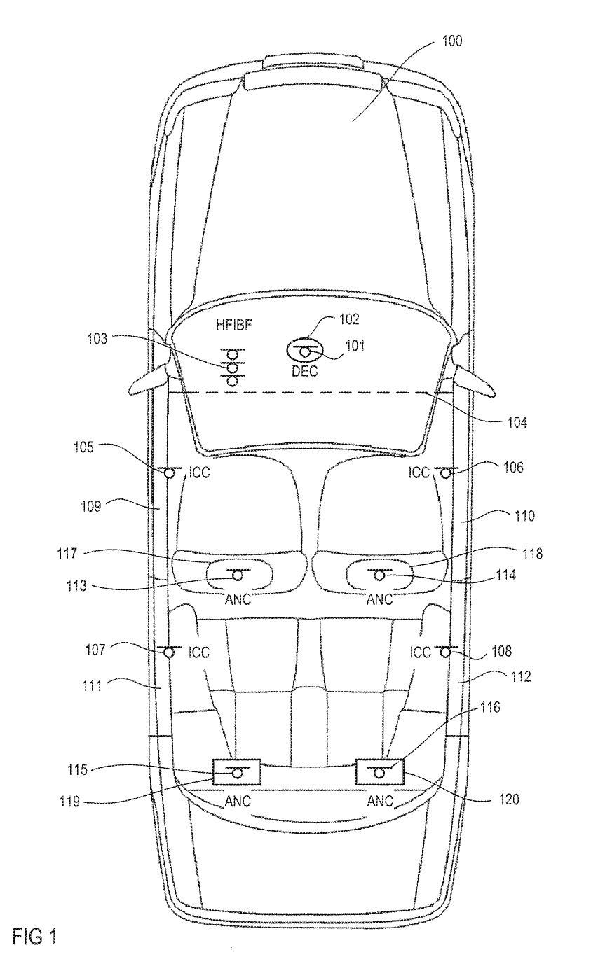

FIG. 1 shows for various sound signal processing systems some typical microphone positions in the interior of a vehicle 100. As can readily be seen, different systems use different microphone positions. For example, the purpose of a dynamic equalization control (DEC) system is to pick-up environmental noise, but it should not react to speech, therefore in this case it is important to find a spot at which these two properties are well provided for—often for this purpose a single dedicated microphone 101 is placed at a rear-view-mirror 102. A dedicated microphone is understood to be a microphone that is optimized at least in terms of position and performance (e.g., directivity, dynamics, sensitivity, frequency characteristics, etc.) for a certain duty, e.g. for dynamic equalization control (DEC), in which case it is also referred to as dynamic equalization control (DEC) microphone. One or more dedicated microphones, e.g., a microphone array 103, used for beamforming (BF) or hands-free communication (HF) may be disposed in a dash board 104 or in the roof liner (not shown) above the dashboard 104. Dedicated microphones 105-108, optimized for an in-vehicle communication or in-car communication (ICC) system, may be placed in the side doors 109-112 or in the roof liner (not shown) above the side doors 109-112. An active noise control (ANC) system may include dedicated microphones 113-116 disposed in the headrests 117-120 of front and rear seats in the vehicle interior. Additionally or alternatively to optimizing the position, some or all microphones may be optimized in terms of performance, e.g., directivity, frequency characteristics, sensitivity, dynamics etc. Even if the goals of such microphone based systems may differ, it has been found to be beneficial to have access to as many microphone signals as possible since the informational content will always be increased, no matter what the different purposes of the systems may be, provided the microphone coupling, e.g., pre-processing and/or combining, is correctly applied.

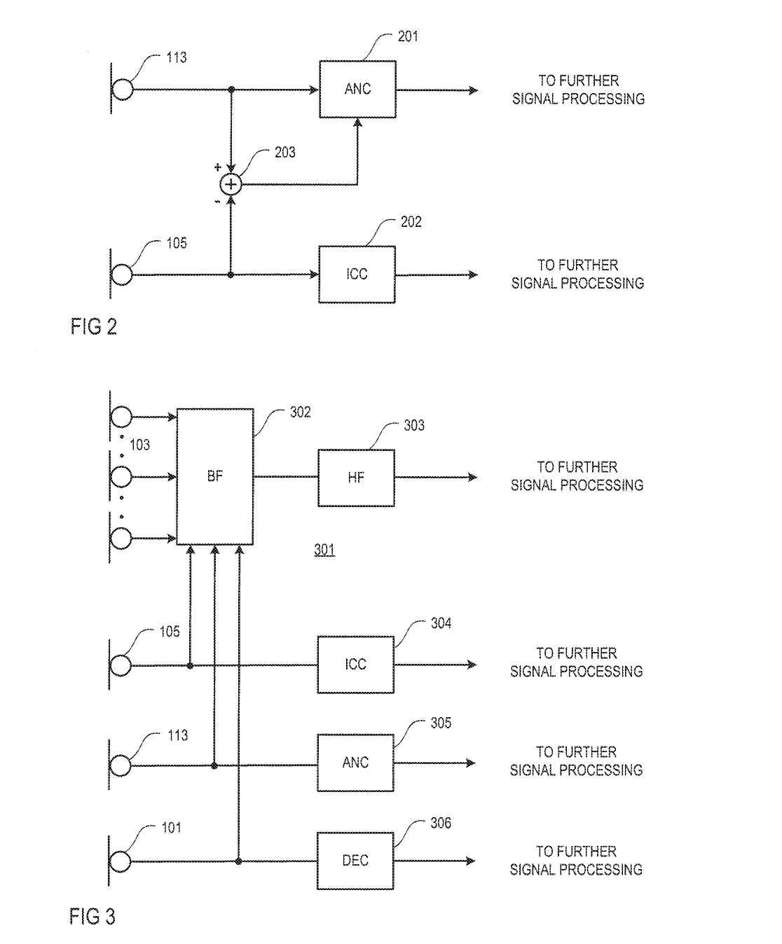

Referring to FIG. 2, in the exemplary case of an ANC module 201 which may include the microphone 113 (also referred to as ANC microphone 113) shown in FIG. 1, the microphone 105 (also referred to as ICC microphone 113) shown in FIG. 1 is linked to an ICC module 202 and is combined with the microphone 113 of ANC system 201 in order to get a deeper insight into a noise field to be controlled by the ANC system. Based on two microphones instead of one close to each seating or head position, not only the sound pressure of the noise field can be derived using the single ANC microphone 113, but also a first approximation of the modal character of the noise field at this position by also evaluating the difference between the signals from the ICC microphone 105 and ANC microphone 113 for the respective position when generating the anti-noise field. Thus, the previously available ANC system, which is only based on the control of the sound pressure, can now, by combining these microphones, be enhanced to control the modes of the sound field, which means that not just the sound pressure but also the velocity of the wave field is taken into consideration during control. In the present example, a subtractor 203 is operatively coupled to the microphones 105 and 113 and serves as a simple signal coupler which supplies to the ANC module 201 another signal which is based on the audio signals from the microphones 105 and 113.

In another example, it is desired to enhance a hands-free system at the driver seat. A basic hands-free system 301 shown in FIG. 3 may include only a single microphone or a microphone array such as microphone array 103 shown in FIG. 1, a beamforming (BF) module 302 connected downstream of the microphone array 103, and a hands-free (HF) module 303 connected downstream of the beamforming module 302. If the microphone array 103 (or a single microphone) of the basic hands-free system 301 is combined with at least one other microphone close to the driver seat, these more or less loosely distributed microphones can be combined to create a distributed beamforming system, able to better suppress background noise, which improves the signal-to-noise-ratio (SNR) and, thus, the hands-free performance. For this, the beamforming module 302 may include additional channels and may further be connected to at least one of microphone 105, which is optimized for an in-vehicle communication or in-car communication (ICC) module 304, microphone 113, which is optimized for an ANC module 305, and microphone 101, which is optimized for a dynamic equalization control (DEC) module 306. Although the above description in connection with FIGS. 1 and 2 refers only to the driver seat position, it is applicable for all other seating positions accordingly.

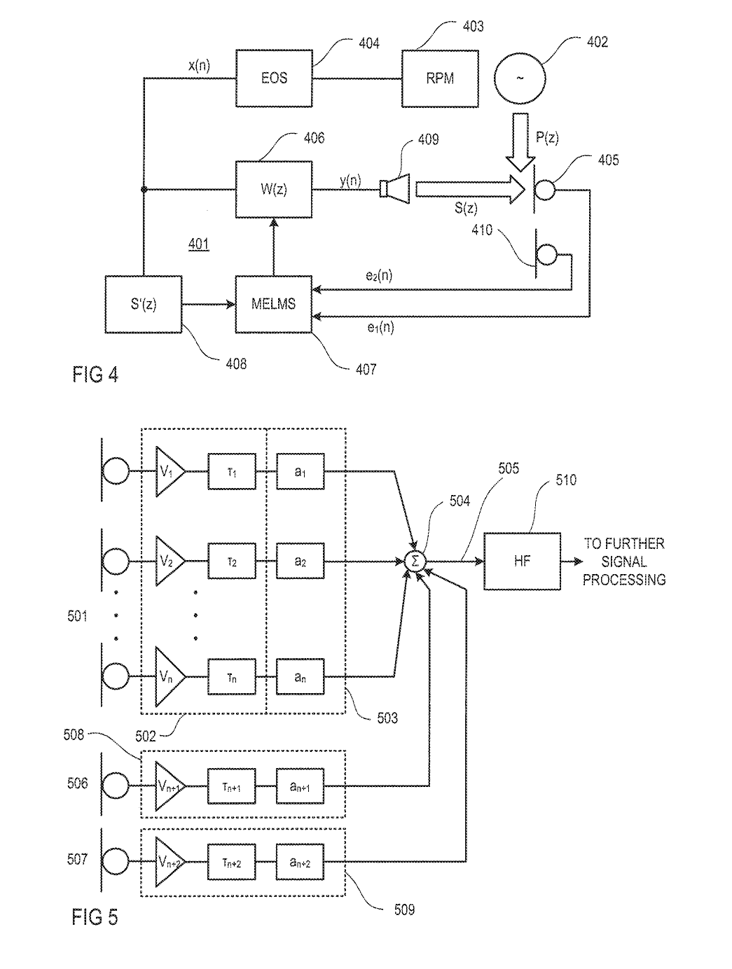

Active noise control (ANC), also known as noise cancellation, or active noise reduction (ANR), is a technique for reducing unwanted sound by the addition of a second sound specifically designed to cancel the first. A simple single-channel feedforward active noise control system 401 may be constructed as shown in FIG. 4. Noise that originates from a noise source, e.g., an engine 402 of a vehicle, is picked up at the engine 402 with a non-acoustic sensor such as a rotations-per-minute (RPM) sensor 403 in connection with an engine order synthesizer 404 which outputs a reference signal x(n) that represents the noise generated by engine 402 and, thus, correlates with the noise audible within the vehicle cabin. At the same time, an error signal e₁(n) representing noise present in the vehicle cabin is detected by a dedicated ANC (error) microphone 405 arranged within the cabin, e.g., in a headrest of the driver's seat similarly to microphone 113 shown in FIG. 1. The noise originating from the engine 402 is mechanically and/or acoustically transferred to dedicated ANC microphone 405 via its corresponding primary path, which has a transfer characteristic P(z).

A transfer characteristic W(z) of a controllable filter 406 is controlled by an adaptive filter controller 407, which may operate according to the known least mean square (LMS) algorithm based on an error signal e₁(n) and on the reference signal x(n) filtered with a transfer characteristic S′(z) by a filter 408, wherein W(z)=−P(z)/S(z) and S′(z)=S(z). S(z) represents the transfer function of a secondary path between a loudspeaker 409 and the microphone 405. A cancellation signal y(n) having a waveform inverse in phase to that of the noise audible within the cabin is generated by an adaptive filter formed by controllable filter 406 and filter controller 407, based on the thus identified transfer characteristic W(z) and the reference signal x(n). From cancellation signal y(n) sound with a waveform inverse in phase to that of the noise audible within the cabin is then generated by loudspeaker 409, which may be arranged in the cabin, to thereby reduce the noise audible in the cabin. The exemplary system described above employs a straightforward single-channel feedforward filtered-x LMS control structure, but other control structures, e.g., multi-channel structures with a multiplicity of additional channels, a multiplicity of additional noise sensors, a multiplicity of additional dedicated microphones, and a multiplicity of additional loudspeakers, may be applied as well.

The system may be enhanced by employing another microphone 410 which may be dedicated, e.g., to in-car communication or hands-free communication (ICC), and, thus, be already present in the car cabin at different position than microphone 405. Microphone 410 provides another error signal e₂(n) to the filter controller 407. Due to the multiplicity of error signals input into filter controller 407, a multiple error least mean square (MELMS) algorithm is employed in filter controller 407 so that the adaptive filter formed by controllable filter 406, filter controller 407 and filter 408 is a multi-channel system operated according to a multiple error filtered-x least mean square algorithm.

Beamforming is a signal processing technique used in sensor arrays (e.g., loudspeaker or microphone arrays) for directional signal transmission or reception. This spatial selectivity is achieved by using adaptive or fixed receive/transmit beam patterns. Beamforming takes advantage of interference to change the directionality of the array. During audio transmission, a beamformer controls the phase and relative amplitude of the signal at each transmitter (e.g., a loudspeaker) in order to create a pattern of constructive and destructive interference in the wave front. During audio detection, information from different sensors (e.g., microphones) is combined such that the expected pattern of radiation is observed.

In a simple beamforming system shown in FIG. 5, signals from n microphones of a dedicated BF microphone array 501 are processed using a beamsteering module 502. The beamsteering module 502 outputs signals to a filtering module 503 whose output signals are summed up by a summer 504 to provide a signal 505. Microphones of the microphone array 501 pickup sound occurring at their respective positions and provide microphone signals representing the picked-up sound. The microphone signals are processed by beamsteering module 502 using gain factors v₁ . . . vₙ and time delays τ₁ . . . τₙ to compensate for the amplitude differences and the transit time differences of the microphone signals. Depending on the distance between the sound source, e.g., a loudspeaker, and the microphone array, as well as on the distance between the microphones and on the sampling frequency, in the case of digital signal processing, more or less propagation or transit time between the microphone signals is to be compensated. The filtering module 503 provides filtering of the amplified/attenuated and time delayed microphone signals with transfer functions a₁ . . . aₙ.

Microphones that are not dedicated to the beamformer, such as microphone 506, which is dedicated to an active noise control system (not shown), and microphone 507, which is dedicated to an in-car communication system (not shown), may be operatively coupled with the summer 504 by way of signal couplers 508 and 509. The signal couplers 508 and 509 may include beamsteering using gain factors vₙ₊₁ and vₙ₊₂, time delays τₙ₊₁ and τₙ₊₂, and filtering of the amplified/attenuated and time delayed microphone signals with transfer functions aₙ₊₁ and aₙ₊₂ to compensate for the spectral amplitude differences and the spectral transit time differences of the signals from microphones 506 and 507, as well as the frequency characteristics of the transfer paths from the sound source to the microphones 506 and 507. The signal may be supplied to a hands-free (HF) module 510.

In an exemplary in-car communication system, a microphone is associated with each passenger seat, including the driver's seat. The microphone is provided near each seat or near the passenger's head. Each microphone picks up the sound of the respective passenger and the corresponding signals are output via loudspeakers in the car. Usually, the existing loudspeakers in the car may be associated to the different passenger seats. If a loudspeaker is mounted in each door, each of the loudspeakers may be associated with the person sitting next the respective door. This allows the signals from a particular passenger's speech to be output mainly by the loudspeakers corresponding to the other passengers in the cabin. For example, if the driver is speaking, a signal corresponding to his speech may be output by all of the loudspeakers except for those near the driver.

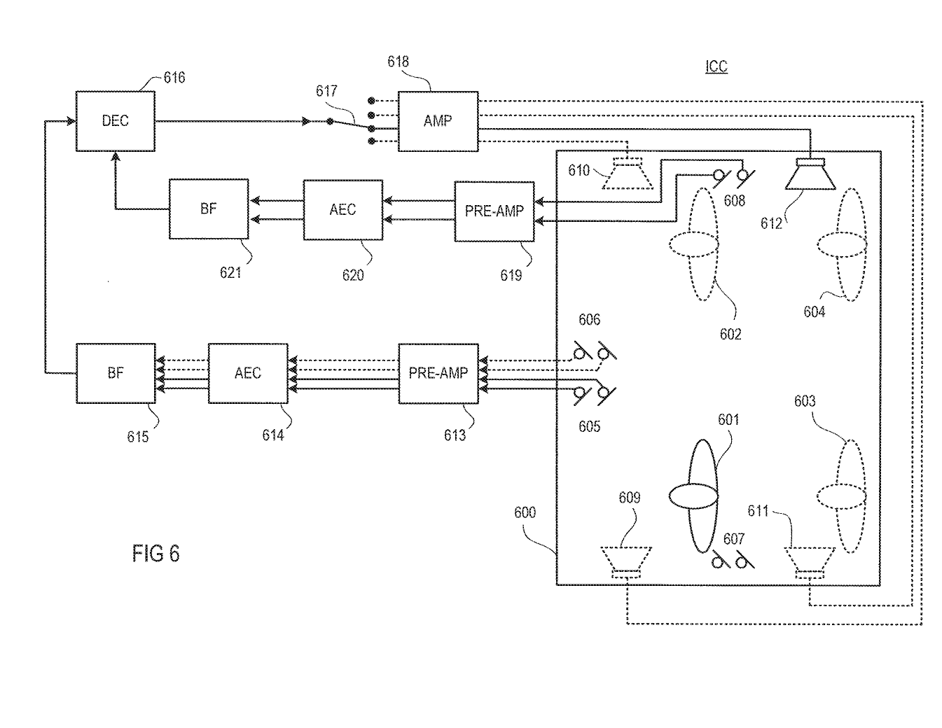

An exemplary in-car communication (ICC) system is illustrated in FIG. 6. A vehicle cabin 600 may include four passenger seats (not shown) for four passengers 601-604. Microphone arrays 605-608, each including two microphones, and loudspeakers 609-612 are associated with each passenger 601-604. For the front passengers 601 and 602, the microphone arrays 605 and 606 may be arranged in the center between the passengers 601 and 602, e.g., in the dash board, roof lining or the rear-view mirror. For the rear seats, the microphone arrays 607 and 608 may be disposed in the left and right side doors, in the corresponding B-pillars or in grab handles. In the example shown in FIG. 6, it is assumed that only the microphone array 605 and the loudspeaker 612 are active. The remaining microphones 606-608 and loudspeakers 609-611, which are not active, are indicated by dashed lines.

The in-car communication system shown in FIG. 6 may include a pre-amplifier (PRE-AMP) module 613 for amplifying a multiplicity of microphone signals provided by, e.g., the microphone array 605 (and optionally also from microphone array 606). The multiplicity of amplified microphone signals from microphone array 605 is supplied to a multi-channel acoustic echo cancellation (AEC) module 614 which is configured to cancel or reduce acoustic echoes, i.e., in the present example sound radiated by the loudspeaker 612 and picked up by microphone array 605, and provides amplified and echo-reduced microphone signals to a beamforming (BF) module 615. Beamforming (BF) module 615 processes the multiplicity of amplified and echo-reduced microphone signals from microphone array 605 to yield a beamformed signal which models a microphone signal from a single microphone with a desired (optionally steerable) directivity. A signal representing the beamformed signal with removed echoes is supplied to a dynamic equalization control (DEC) module 616. The signal output by the dynamic equalization control (DEC) module 616 is supplied to a switch 617 which may be included to address each loudspeaker 609-612 independently of the other loudspeakers. Before the output signal from dynamic equalization control module 616 is supplied to one, some or all of the loudspeakers 609-612, it is amplified with a (power) amplifier (AMP) module 618.

The in-car communication (ICC) system shown in FIG. 6 may be enhanced by way of (at least) one of the other microphones or microphone arrays present in the cabin, e.g., by way of microphone array 608 which is disposed adjacent to passenger 604 at the rear right seat. Microphone array 608 supplies a multiplicity of microphone signals to a pre-amplifier (PRE-AMP) module 619 for amplifying the multiplicity of microphone signals from microphone array 608. The multiplicity of amplified microphone signals from microphone array 608 is supplied to a multi-channel automatic echo cancellation (AEC) module 620 which is configured to cancel or reduce acoustic echoes, i.e., in the example shown in FIG. 6, sound radiated by the loudspeaker 612 is picked up by microphone array 608, and provides amplified and echo-reduced microphone signals to a beamforming (BF) module 621.

Beamforming (BF) module 621 processes the multiplicity of amplified and echo-reduced microphone signals from microphone array 608 to yield a beamformed signal which models a microphone signal from a single microphone with a desired (optionally steerable) directivity. The output signal of the beamforming module 621, which uses the additional microphone signals from microphone array 608 to assess the noise present in the cabin at the desired receiving position of the in-car communication (ICC) system, so that speech from position 601 should be enhanced at position 604, is used in the dynamic equalization control (DEC) module 616 to dynamically adapt the volume or equalization of the beamformed signal (desired speech signal) from the beamformer (BF) module 615. While beamformer (BF) module 615 in connection with microphone array 605 is configured (or steered) to have its maximum sensitivity in the direction of passenger 601, beamformer (BF) module 621 in connection with microphone array 608 may be configured (or steered) to have its maximum sensitivity in the direction of the passenger's head, specifically his/her ears, at the desired receiving position 604, ideally without picking up positional speech signals from this position. Hence, directing a steered beam based on the microphone array 608, e.g., towards the headliner above the head position of 604, may be adequate.

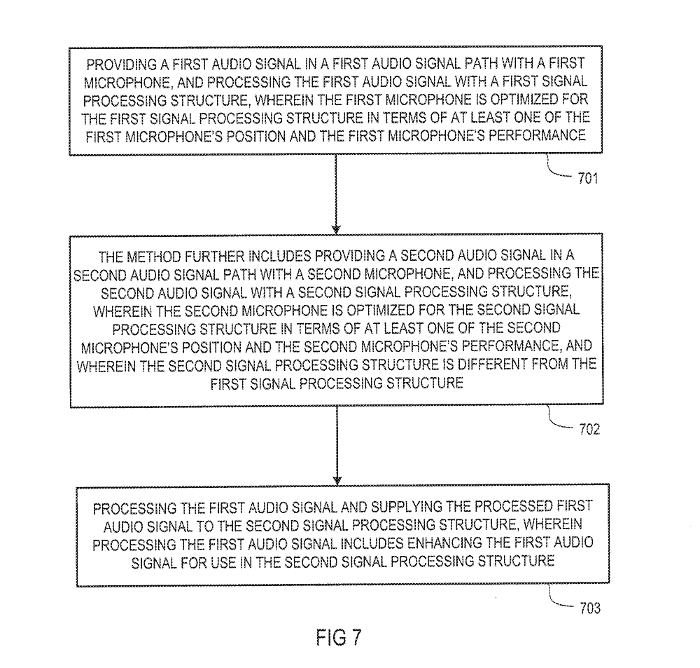

An exemplary audio enhancement method as shown in FIG. 7 includes providing a first audio signal in a first audio signal path with a first microphone, and processing the first audio signal with a first signal processing structure, wherein the first microphone is optimized for the first signal processing structure in terms of at least one of the first microphone's position and the first microphone's performance (procedure 701). The method further includes providing a second audio signal in a second audio signal path with a second microphone, and processing the second audio signal with a second signal processing structure, wherein the second microphone is optimized for the second signal processing structure in terms of at least one of the second microphone's position and the second microphone's performance, and wherein the second signal processing structure is different from the first signal processing structure (procedure 702). The method still further includes processing the first audio signal and supplying the processed first audio signal to the second signal processing structure, wherein processing the first audio signal includes enhancing the first audio signal for use in the second signal processing structure (procedure 703).

Different systems such as, for example, dynamic equalization control, in-vehicle communication, active noise control, hands-free communication, sound shower, adaptive/dynamic bass/sound field management/enhancement and beamforming may be combined to enhance the performance of one, some or all of the systems combined.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices, such as in the systems described with reference to FIGS. 2 to 6. The described method and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

What is claimed is:

1. An audio enhancement system comprising:
a first audio signal path with a first microphone configured to provide a first audio signal, and with a first signal processing structure configured to process the first audio signal, wherein the first microphone is optimized for the first signal processing structure in terms of at least one of a position of the first microphone and a performance of the first microphone;
a second audio signal path with a second microphone configured to provide a second audio signal, and with a second signal processing structure configured to process the second audio signal, wherein the second microphone is optimized for the second signal processing structure in terms of at least one of a position of the second microphone and a performance of the second microphone, and wherein the second signal processing structure is different from the first signal processing structure; and
a signal coupler configured to process the first audio signal and to supply the processed first audio signal to the second signal processing structure, wherein processing the first audio signal includes enhancing the first audio signal for use in the second signal processing structure.

2. The system of claim 1, wherein the signal coupler is further configured to process the second audio signal and to supply the processed second audio signal to the first signal processing structure, wherein processing the second audio signal includes enhancing the second audio signal for use in the first signal processing structure.

3. The system of claim 1, wherein the first audio signal path and/or the second audio signal path are configured to provide at least one of dynamic equalization control, in-vehicle communication, active noise control, hands-free communication, sound shower, adaptive or dynamic sound field enhancement and beamforming.

4. The system of claim 1, wherein the first audio signal path is configured to provide active noise control or in-vehicle communication, and the second audio signal path is configured to provide in-vehicle communication or active noise control.

5. The system of claim 1, wherein the first audio signal path is configured to provide hands-free communication, and the second audio signal path is configured to provide beamforming, dynamic equalization control, in-vehicle communication or active noise control.

6. The system of claim 1, wherein:
the position of at least one of a first microphone and a second microphone that is optimized for active noise control is close to a passenger's ear;
the position of the at least one of the first microphone and the second microphone that is optimized for in-vehicle communication is close to a passenger's mouth;
the position of the at least one of a first microphone and a second microphone that is optimized for beamforming is close to a passenger's mouth;
the position of the at least one of a first microphone and a second microphone that is optimized for hands-free communication is close to a passenger's mouth; and
the position of the at least one of a first microphone and a second microphone that is optimized for dynamic equalization control is close to a passenger's ear.

7. The system of claim 1, further comprising:
at least one additional audio signal path with an additional microphone providing an additional audio signal, and the first signal processing structure is configured to process the first audio signal, wherein the first microphone is optimized in terms of at least one of position and performance for the first signal processing structure; wherein:
the signal coupler is further configured to process the second audio signal and to supply the processed second audio signal to the first signal processing structure, wherein processing the second audio signal includes enhancing the second audio signal for use in the first signal processing structure.

8. The system of claim 1, wherein at least one of the first audio signal path, the second audio signal path and an additional audio signal path comprises at least two microphones optimized for the respective signal processing structure in terms of at least one of position and performance.

9. An audio enhancement method comprising:
providing a first audio signal in a first audio signal path with a first microphone, and processing the first audio signal with a first signal processing structure, wherein the first microphone is optimized for the first signal processing structure in terms of at least one of a position of the first microphone and a performance of the first microphone;
providing a second audio signal in a second audio signal path with a second microphone, and processing the second audio signal with a second signal processing structure, wherein the second microphone is optimized for the second signal processing structure in terms of at least one a position of the second microphone and a performance of the second microphone, and wherein the second signal processing structure is different from the first signal processing structure; and
processing the first audio signal and supplying the processed first audio signal to the second signal processing structure, wherein processing the first audio signal includes enhancing the first audio signal for use in the second signal processing structure.

10. The method of claim 9, further comprising processing the second audio signal and supplying the processed second audio signal to the first signal processing structure, wherein processing the second audio signal includes enhancing the second audio signal for use in the first signal processing structure.

11. The method of claim 10, further comprising providing at least one of dynamic equalization control, in-vehicle communication, active noise control, hands-free communication, sound shower, adaptive or dynamic sound field enhancement and beamforming in the first audio signal path and/or the second audio signal path.

12. The method of claim 10, further comprising providing active noise control or in-vehicle communication in the first audio signal path, and providing in-vehicle communication or active noise control in the second audio signal path.

13. The method of claim 10, further comprising providing hands-free communication in the first audio signal path, and providing beamforming, dynamic equalization control, in-vehicle communication or active noise control in the second audio signal path.

14. The method of claim 9, wherein:
the position of at least one first microphone and the second microphone that is optimized for active noise control is close to a passenger's ear;
the position of the at least one first microphone and the second microphone is optimized for in-vehicle communication is close to a passenger's mouth;
the position of the at least one first microphone and the second microphone that is optimized for beamforming is close to a passenger's mouth;
the position of the at least one first microphone and the second microphone that is optimized for hands-free communication is close to a passenger's mouth; and
the position of the at least one first microphone and the second microphone that is optimized for dynamic equalization control is close to a passenger's ear.

15. The method of claim 9, further comprising:
providing an additional audio signal in at least one additional audio signal path with an additional microphone, and processing the first audio signal in an first signal processing structure, wherein the first microphone is optimized in terms of at least one of position and performance for the first signal processing structure; and
processing the second audio signal and supplying the processed second audio signal to the first signal processing structure, wherein processing the second audio signal includes enhancing the second audio signal for use in the first signal processing structure.

16. An audio enhancement system comprising:
a first microphone configured to provide a first audio signal;
a first signal processing structure configured to process the first audio signal, wherein the first microphone is optimized for the first signal processing structure in terms of at least one of a position of the first microphone and a performance of the first microphone;
a second microphone configured to provide a second audio signal;
a second signal processing structure configured to process the second audio signal, wherein the second microphone is optimized for the second signal processing structure in terms of at least one of a position of the second microphone and a performance of the second microphone; and
a signal coupler configured to process the first audio signal and to supply the processed first audio signal to the second signal processing structure, wherein processing the first audio signal includes enhancing the first audio signal for use in the second signal processing structure.

17. The system of claim 16, wherein a first audio signal path and/or a second audio signal path are configured to provide at least one of dynamic equalization control, in-vehicle communication, active noise control, hands-free communication, sound shower, adaptive or dynamic sound field enhancement and beamforming.

18. The system of claim 17, further comprising:
at least one additional audio signal path with an additional microphone providing an additional audio signal, and the first signal processing structure is configured to process the first audio signal, wherein the first microphone is optimized in terms of at least one of position and performance for the first signal processing structure; wherein:
the signal coupler is further configured to process the second audio signal and to supply the processed second audio signal to the first signal processing structure, wherein processing the second audio signal includes enhancing the second audio signal for use in the first signal processing structure.

19. The system of claim 17, wherein at least one of the first audio signal path, the second audio signal path and an additional audio signal path comprises at least two microphones optimized for the respective signal processing structure in terms of at least one of position and performance.

20. The system of claim 16, wherein:
the position of at least one of the first microphone and the second microphone that is optimized for active noise control is close to a passenger's ear;
the position of the at least one first microphone and the second microphone that is optimized for in-vehicle communication is close to a passenger's mouth;
the position of the at least one first microphone and the second microphone that is optimized for beamforming is close to a passenger's mouth;
the position of the at least one first microphone and the second microphone that is optimized for hands-free communication is close to a passenger's mouth; and
the position of the at least one first microphone and the second microphone that is optimized for dynamic equalization control is close to a passenger's ear.
